(19) United States
(12) Patent Application Publication
(10) Pub. No.: US 2018/0111142 A1
(43) Pub. Date: Apr. 26, 2018

(54) FLUID SPRAY GUN, FILTER FOR SUCH A GUN, AND METHOD FOR EXTRACTING A FILTER OUT OF SUCH A GUN

(71) Applicant: EXEL INDUSTRIES, Epemay (FR)

(72) Inventors: Fabrice JOAQUIM, STAINS (FR); Nicolas BAILLETTE, BOULOGNE-BILLANCOURT (FR)

(73) Assignee: EXEL INDUSTRIES, Epernay (FR)

(21) Appl. No.: 15/548,225

(22) PCT Filed: Feb. 11, 2016
(86) PCT No.: PCT/EP2016/052869

§ 371 Date: Dec. 22, 2017

(30) Foreign Application Priority Data
Feb. 12, 2015 (FR) 1551167

(51) Int. Cl. B05B 9/01; B05B 15/00

(52) U.S. Cl. CPC B05B 9/01; B05B 15/001; B05B 15/008

(57) ABSTRACT

The present invention concerns a fluid spray gun (10), comprising a body (15) consisting of a barrel (65) supporting a fluid spray nozzle (30) and a handle (70) having a cavity (72) for receiving a filter (55), open opposite the barrel (65), and a guard (50) suitable for protecting the hand of a user against impacts, the guard (50) being removably mounted on the body (15) and having a first end (E1) secured to the barrel (65) and a second end (E2) secured to the handle (70). The guard (50) comprises extraction means (115) for extracting the filter (55) out of the cavity (72).

### CROSS-REFERENCE TO RELATED APPLICATIONS

The present application is a United States national stage application under 35 U.S.C. § 371 of international patent application number PCT/EP2016/052869, filed Feb. 11, 2016, 2016, which claims priority to French patent application No. 1551167, filed Feb. 12, 2015, the entireties of which are incorporated herein by reference.

### BACKGROUND OF THE INVENTION

The present invention relates to a fluid spray gun, comprising a body made up of a barrel supporting a fluid spray nozzle and a handle having a cavity for receiving a filter, open opposite the barrel, and a guard suitable for protecting the hand of a user against impacts and preventing accidental operation in case of fall, the guard being removably mounted on the body and having a first end secured to the barrel and a second end secured to the handle. Alternatively, the guard is mounted secured on the body.

Fluid spray devices frequently include a gun, allowing easy grasping by the user. In order to make it easier for a user to handle, the gun is generally supplied by a supply hose connected to the lower end of the handle. In this configuration, the handle is hollow so as to allow fluid to pass. During operation, the fluid therefore traverses the handle, then the barrel before reaching a nozzle allowing uniform spraying of the fluid on a surface.

Such guns are for example used to spray a fluid intended to coat surfaces, such as paint. In order to prevent the gun or the nozzle that it bears from becoming plugged, these guns generally include a filter making it possible to retain, upstream from the nozzle, the impurities present in the fluid.

A gun of this type is known from document U.S. Pat. No. 5,370,314 A, including a filter received in a cavity of the handle. This gun further includes a guard intended to protect the hand of the user from any impacts and to avoid accidental operation in case of fall. This guard has two ends, one being fastened to the barrel and the other to the handle. The guard further includes a polygonal cavity complementary to the handle, making it possible to unscrew the latter relative to the barrel. Such a gun therefore makes it possible to disassemble the handle from the barrel without using any additional tools.

However, if a user leaves the gun unused for several hours, the paint contained in the gun dries and blocks the filter inside the handle. It is then necessary to exert a significant pulling force on the filter in order to remove the filter from the handle. To that end, the user must frequently use an additional tool, such as pliers, to grasp one end of the filter protruding from the handle.

### SUMMARY OF THE INVENTION

The aim of the invention is to propose a fluid spray gun allowing easy removal of the filter from the handle.

To that end, the invention relates to a fluid spray gun of the aforementioned type, wherein the guard comprises means for removing the filter from the cavity. According to other advantageous aspects of the invention, the gun comprises one or more of the following features, considered alone or according to all technically possible combinations:

the filter is translatable relative to the handle and can be removed from the cavity, along a longitudinal direction of the handle moving away from the barrel, and the removal means are able to secure the filter and the guard in translation along this direction;

the filter has a groove and the removal means of the guard have a notch, the edge of which is configured to be engaged in the groove;

the guard is in a single piece;

the first end has two elastic arms, the free ends of which are configured to be engaged in two corresponding housings provided on the barrel;

the gun further comprises a maintaining element able to be secured to the handle in a first position in which the maintaining element prevents the removal of the filter from the cavity, and the guard further includes means for maneuvering the maintaining element relative to the handle;

the maintaining element is able to be screwed to the handle and the maneuvering means are able to screw or unscrew the maintaining element relative to the handle;

the maintaining element has a polygonal exterior shape and the maneuvering means have a cavity with a shape complementary to the exterior shape of the maintaining element;

the barrel bears a seat casing able to receive a seat of a fluid spray nozzle by bearing, the seat casing being screwed to the barrel and the guard further including means for unscrewing the seat casing relative to the barrel, while the gun further includes a trigger pivoting around an axis traversing the body, and the guard includes means for disassembling the axis relative to the body.

The invention also relates to a filter for a fluid spray gun, the filter having a first end oriented toward the top of the handle and a second end oriented toward the bottom of the handle when the filter is received in the cavity, wherein the second end comprises means complementary to the removal means provided on the guard.

According to another advantageous aspect of the invention, the first end has a cylindrical fluid intake opening, the cylindrical opening having a polygonal base.

The invention also relates to a method for removing a filter from the handle of a fluid spray gun, comprising a body made up of a barrel supporting a fluid spray nozzle and a handle having a cavity for receiving a filter, open opposite the barrel, and a guard suitable for protecting the hand of a user against impacts and preventing accidental operation in case of fall, the guard having a first end secured to the barrel and a second end secured to the handle, the method comprising the following steps:

separating the first end and the barrel,

securing the guard and the filter in translation, and

removing the filter from the cavity using the guard.

### BRIEF DESCRIPTION OF THE DRAWINGS

The features and advantages of the invention will appear upon reading the following description, provided solely as a non-limiting example, and done in reference to the appended drawings, in which:

FIG. 1 is a perspective view of a gun according to the invention, including a guard, a handle defining a cavity for receiving a filter, and an element maintaining the filter in the cavity,

FIG. 2 is an exploded perspective view of the gun of FIG. 1,

FIG. 3 is a perspective view of the guard of the gun of FIGS. 1 and 2, including means for removing a filter from a cavity and means for maneuvering a maintaining element relative to the handle,

FIG. 4 is a detail of the gun of FIG. 1, wherein the maintaining element has been unscrewed from the handle,

FIG. 5 is a detail of the gun of FIG. 1, wherein the removal means have been secured in translation with the filter, and the filter is partially removed from the cavity,

FIG. 6 is a perspective view of a second example gun according to the invention, and

FIG. 7 is a flowchart of the steps of a method for removing a filter from the handle of a gun according to the invention.

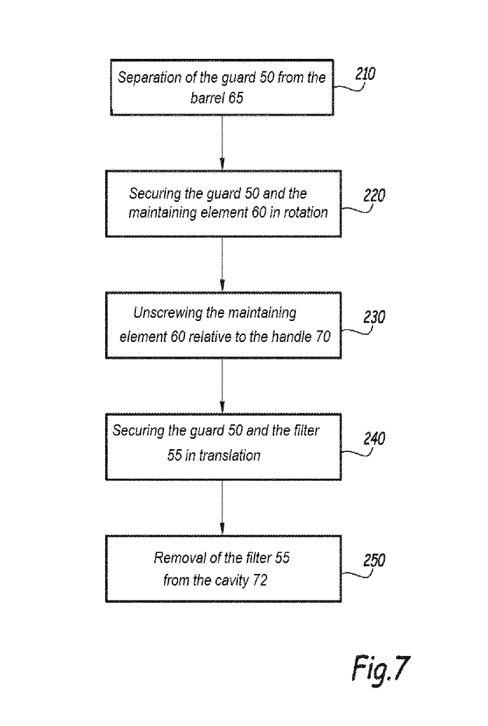

### DETAILED DESCRIPTION OF PREFERRED EMBODIMENTS

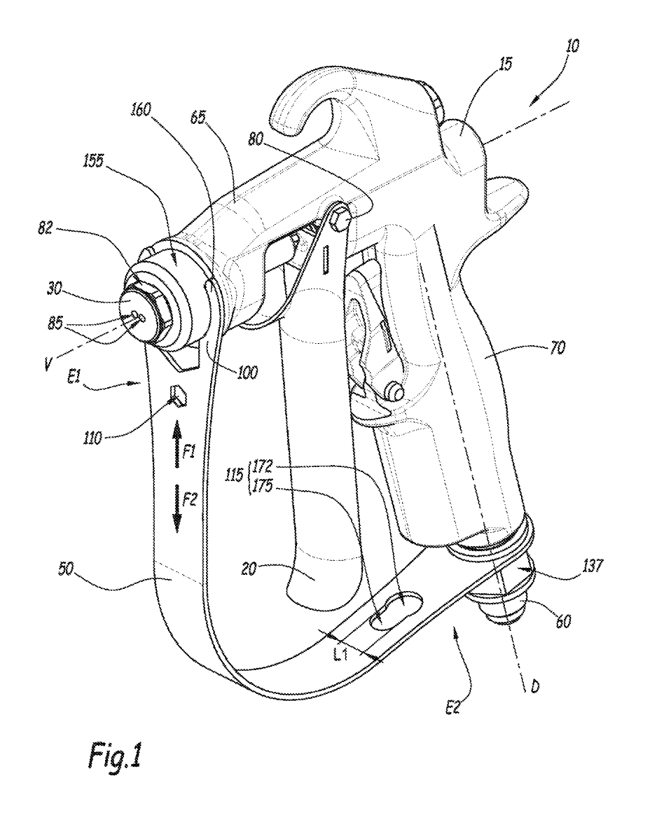

A fluid F spray gun 10 is shown in FIG. 1. The gun 10 comprises a body 15, a trigger 20, an axis 25, a seat casing 30, a seat 35, a base 40, a nozzle 45, a guard 50, a filter 55 and an element 60 maintaining the filter 55 relative to the body 15.

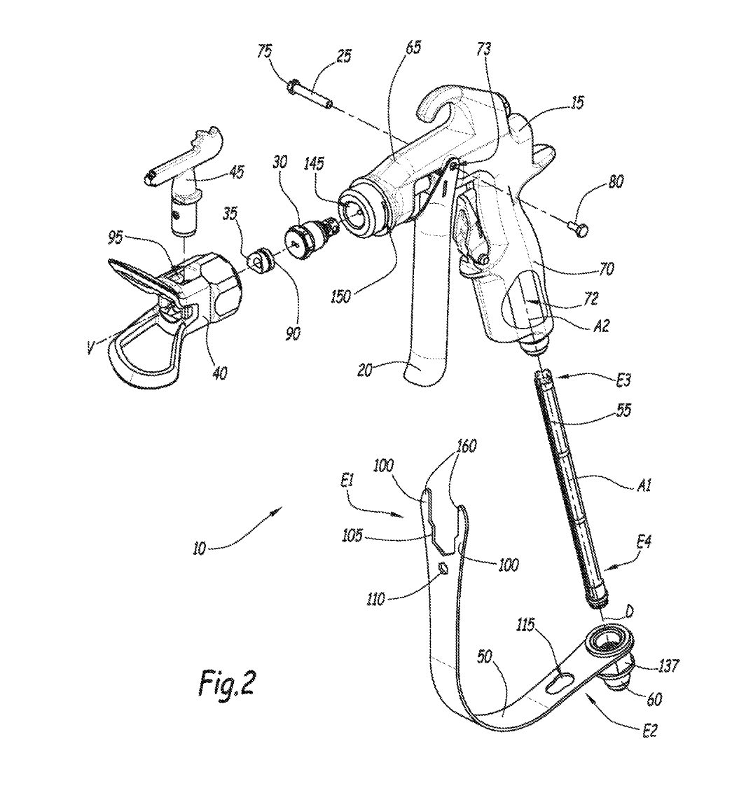

To simplify the drawing, the base 40 and the nozzle 45 are not shown in FIG. 1. The base 40 and the nozzle 45 are shown in FIG. 2.

The fluid F is for example a coating product. Preferably, the fluid F is a paint.

The body 15 is made in a single piece. The body 15 is made from metal. For example, the body 15 is made from aluminum, preferably by coining. Alternatively, the body 15 can be made from a synthetic material, for example a polymer containing fibrous reinforcements. The body 15 comprises a barrel 65 and a handle 70 defining a cavity 72 for receiving the filter 55. Part of the cavity 72 is visible by cutaway in FIG. 2.

The trigger 20 is able to actuate a control mechanism (not shown) for a flow rate of the fluid F. The trigger 20 is movable relative to the body 15. For example, the trigger 20 is rotatable around the axis 25 relative to the body 15.

The trigger 20 has two openings 73 for guiding the axis 25.

The axis 25 traverses the body 15 and the two guide openings 73.

The axis 25 has a polygonal head 75. Preferably, the head 75 is split. The axis 25 further bears a screw 80 with a polygonal head. The screw 80 is able to prevent the removal of the axis 25 from the body 15 and guide openings 73 when the screw 80 is screwed with the axis 25. The axis 25 and the screw 70 are preferably made from a metal, such as stainless steel.

The seat casing 30 is able to receive the seat 35 by bearing.

The seat casing 30 is screwed to the barrel 65. The seat casing has a first polygonal exterior shape 82 and two passage holes 85 for the fluid F.

The first exterior shape 82 is cylindrical with a polygonal base, for example a hexagonal base.

The seat casing 30 is preferably made from a metal material. For example, the seat casing 30 is made from stainless steel.

The seat 35 is able to guide the rotation of the nozzle 45 relative to the body 15.

The seat 35 is preferably made from a metal, such as steel. The seat 35 bears a barrel gasket 90.

The base 40 has a first opening 95 for receiving the nozzle 45. The base 40 is screwed to the barrel 65. The base 40 is configured to press the nozzle 45 against the seat 35 and to press the seat 35 and the gasket 90 against the seat casing 30 when the base 40 is screwed to the barrel 65 and the nozzle 45 is received in the first receiving opening 95.

The guard 50 is able to protect the hand of a user against impacts and to prevent accidental operation in case of fall. The guard 50 is mounted removably on the body 15. Alternatively, the guard 50 is mounted secured on the body 15.

The guard 50 is in a single piece. The guard 50 is made from a metal material. The guard 50 is for example made from stainless steel.

The guard 50 has a first end E1 fastened to the barrel 65, and a second end E2 fastened to the handle 70.

According to the example of FIG. 1, the first end E1 has two elastic arms 100, means 105 for unscrewing the seat casing 30 relative to the barrel 65, and means 110 for disassembling the axis 25 relative to the body 15.

The second end E2 comprises means 115 for removing the filter 55 from the cavity 72 and means 120 for maneuvering the maintaining element 60.

The filter 55 is received in the cavity 72. The filter 55 is translatable relative to the handle 70.

The filter 55 is substantially cylindrical, with a circular base, and extends along a first axis A1.

The filter 55 has a third end E3 oriented toward the top of the handle 70 when the filter 55 is received in the cavity 72. The filter 55 further has a fourth end E4 oriented toward the bottom of the handle 70 when the filter 55 is received in the cavity 72.

The filter 55 is for example made from a plastic material.

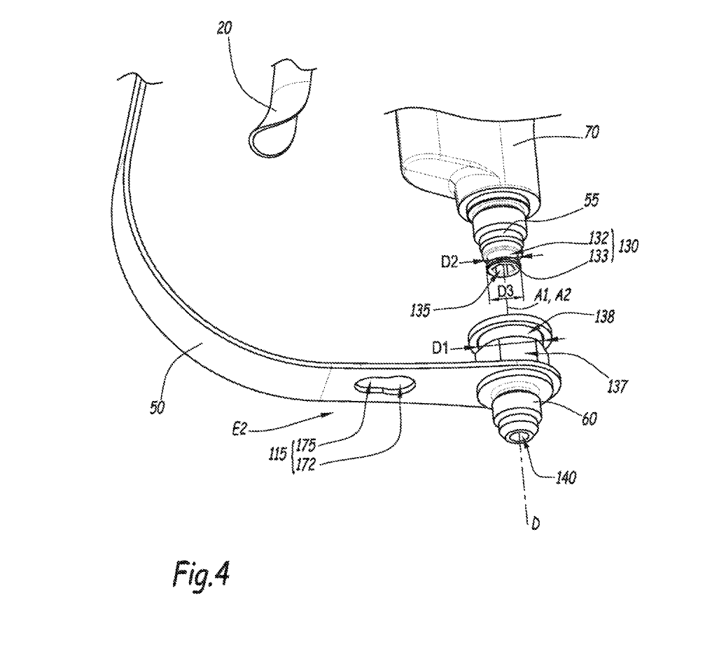

The fourth end E4 comprises means 130 complementary to the removal means 115. According to the example of FIG. 4, the complementary means 130 have a cylindrical groove 132 delimited along the first axis A1 by a ring 133.

The fourth end E4 further has a cylindrical fluid F intake opening 135. The maintaining element 60 is able to be secured to the handle 70 in a first position in which the maintaining element 60 prevents the removal of the filter 55 from the cavity 72. For example, the maintaining element 60 is able to be screwed to the handle 70.

The maintaining element 60 is movable relative to the handle 70 between the first position and a second position, wherein the maintaining element 60 does not prevent the removal of the filter 55 from the cavity 72.

The maintaining element 60 has a polygonal second exterior shape 137. Alternatively or additionally, the maintaining element 60 has a cylindrical portion 138. The cylindrical portion 138 has a first diameter D1.

The maintaining element 60 has a passage hole 140 for the fluid F. The passage hole 140 of the fluid F is for example cylindrical with a circular base.

The maintaining element 60 is made from a metal material. For example, the maintaining element 60 is made from brass.

The barrel 65 is able to support the seat casing 30, the base the 40 and the nozzle 45.

The barrel 65 has a second opening 145 for receiving the seat casing 30. The second receiving opening 145 is for example tapped.

The barrel 65 extends substantially along an aiming direction V.

The barrel 65 further has two housings 150 for receiving elastic arms 100. The housings 150 are complementary to the elastic arms 100. For example, the housings 150 are substantially perpendicular to the aiming direction V.

The barrel 65 further has fastening means 155 of the base 40. The fastening means 155 are for example made in the form of a thread on the outside of the barrel 65.

The handle 70 is able to allow grasping of the gun 10 by a user. The handle 70 extends substantially along a longitudinal direction D.

The receiving cavity 72 is preferably cylindrical. The receiving cavity 72 has a second axis A2. The second axis A2 is preferably combined with the longitudinal direction D of the handle 70.

The cavity 72 is open opposite the barrel 65.

When the filter 55 is received in the cavity 72, the first axis A1 is combined with the second axis A2.

The filter 55 can be removed from the cavity 72 through a translational movement along the longitudinal direction D of the handle 70, moving away from the barrel 65.

Each elastic arm 100 has a free end 160. Each free end 160 is configured to be engaged in a corresponding housing 150 of the barrel 65.

The elastic arms 100 are integral with the guard 50.

The elastic arms 100 define the unscrewing means 105.

The unscrewing means 105 are able to unscrew the seat casing 35 relative to the barrel 65.

The unscrewing means of the seat casing 30 are made in the form of a first cavity 105. The first cavity 105 is polygonal and complementary to the first exterior shape 82 of the seat casing 30.

The disassembly means 110 are able to disassemble the axis 25 relative to the body 15. For example, the disassembly means 110 are configured to unscrew the screw 80 relative to the axis 25.

The disassembly means 110 are made in the form of a second cavity 110. The second polygonal cavity 110 is complementary to the head 75. Alternatively or additionally, the second polygonal cavity 110 is complementary to the screw 80.

The removal means 115 are able to secure the filter 55 and the guard 50 in translation along the longitudinal direction D of the handle 70.

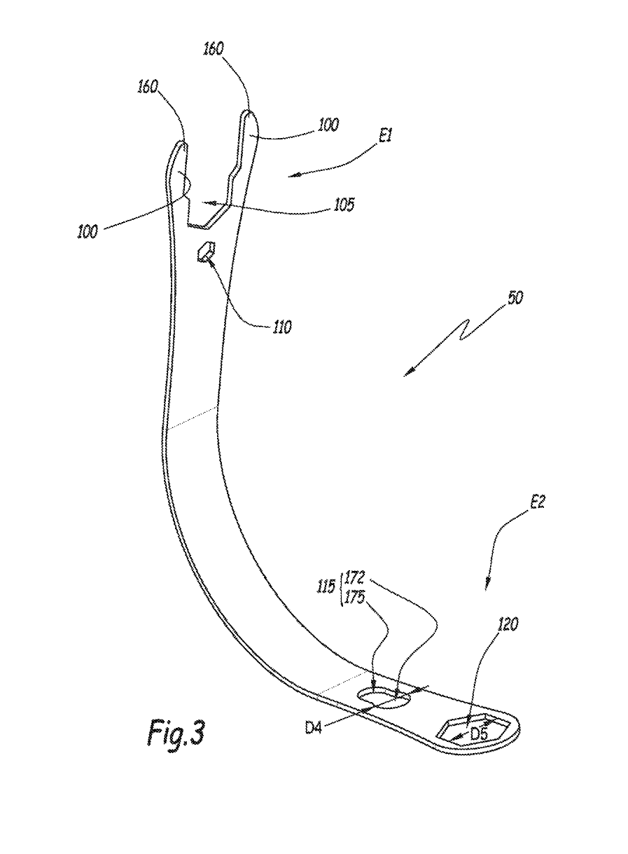

As shown in FIG. 3, the removal means 115 have a third cavity 172 and a notch 175 that emerges in the cavity 172.

The maneuvering means 120 are able to maneuver the maintaining element 60 relative to the handle 70. In practice, the maneuvering means 120 are able to screw or unscrew the maintaining element 60 relative to the handle 70.

The maneuvering means 120 are made in the form of a fourth cavity 120. The fourth cavity 120 is polygonal and complementary to the second exterior shape of the seat casing 137.

In FIG. 3, the fourth cavity 120 is hexagonal. The fourth cavity 120 has a fifth diameter D5. The fifth diameter D5 is defined as the minimum distance between two points borne by opposite sides of the fourth cavity 120. The fifth diameter D5 is strictly larger than the first diameter D1.

The groove 132 is cylindrical, and has a second groove bottom diameter D2.

When the filter 55 is received in the cavity 72, the groove 132 is positioned between the ring 133 and the third end E3 along the first axis A1.

The ring 133 is cylindrical around the first axis A1. The ring 133 has a third diameter D3 strictly larger than the second diameter D2.

The cylindrical opening 135 has a polygonal base, preferably a hexagonal base.

The axis of the cylindrical opening 135 is the first axis A1.

The second exterior shape 137 is cylindrical with a polygonal base.

The free ends 160 are configured to grip the barrel 65 in a plane perpendicular to the aiming direction V. For example, the free ends 160 are configured to be inserted in the housings 150 through a translational movement perpendicular to the aiming direction V, in the direction of arrow F1 in FIG. 1.

The free ends 160 are removable relative to the housings 150. For example, the free ends 160 are configured to be removed from the housings 150 through a pulling movement perpendicular to the aiming direction V. The third cavity 172 is circular. The third cavity 172 has a fourth diameter D4 strictly larger than the second diameter D2 and the third diameter D3.

The notch 175 is complementary to the groove 132. This means that the edge of the notch 175 is configured to be engaged in the groove 132. For example, the notch 175 has a first width L1 larger than or equal to the second diameter D2 and strictly smaller than the third diameter D3.

When the filter 55 is received in the cavity 72, and the edge of the notch 175 is engaged in the groove 132, the filter 55 is secured in translation with the guard 50 along the longitudinal direction D of the handle 70.

The removal of the filter 55 from the cavity 72 will now be described.

When the gun 10 is assembled, the guard 50 is in an assembled position relative to the body 15. In the assembled position, the first end E1 of the guard 50 is fastened to the barrel 65. This means that the free ends 160 are received in the housings 150.

Furthermore, in the assembled position, the fourth cavity 120 partially surrounds the cylindrical portion 138 of the maintaining element 60. The maintaining element 60 is screwed to the handle 70 in the first position.

In a first step 210, the free ends 160 are removed from the housings 150 by pulling in the direction of arrow F2 in FIG. 1 along a direction perpendicular to the aiming direction V. The first end E1 of the guard 50 is therefore separated from the barrel 65. This is obtained by an elastic deformation of the guard 50.

In a second step 220, the guard 50 is moved in the longitudinal direction D of the handle 70 toward a maneuvering position in which the guard 50 and the maintaining element 60 are secured in rotation. This means that the fourth cavity 120 surrounds the second shape 137 in a plane perpendicular to the longitudinal direction D. The guard 50 and the maintaining element 60 are therefore secured in rotation around the longitudinal direction D.

In a third step 230, the maintaining element 60 is unscrewed relative to the handle 70 by rotating the guard 50 around the second axis A2. The maintaining element 60 is moved from the first position to the second position.

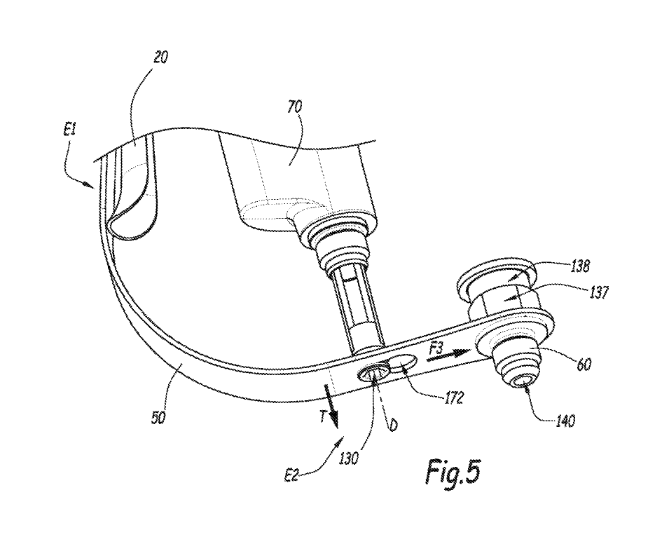

In a fourth step 240, the guard 50 and the filter 55 are secured in translation along the longitudinal direction D. To that end, the fourth end E4 is inserted into the third cavity 172, then the edge of the notch 175 is engaged in the groove 133 by a translational movement along a direction perpendicular to the longitudinal direction D, in the direction of arrow F3 in FIG. 5.

In a fifth step 250, the filter 55 is removed from the cavity 72 owing to the application, by the user, of a pulling force T parallel to the longitudinal direction D and oriented opposite the barrel 65.

The guard 50 therefore allows the filter 55 to be removed from the cavity 72 easily and without additional tools. The guard 50 also allows easy disassembly of the seat casing 30 and the axis 25 without additional tools.

Furthermore, the polygonal cylindrical opening 135 allows a user to exert atorsion torque on the filter 55 around the longitudinal direction D. For example, the user exerts a torque using an Allen key complementary to the cylindrical opening 135. It is therefore not possible for a user to unblock the filter 55 if it is jammed in the cavity 72 by dried paint. The user next removes the filter 55 from the cavity 72 using removal means 115 of the guard 50.

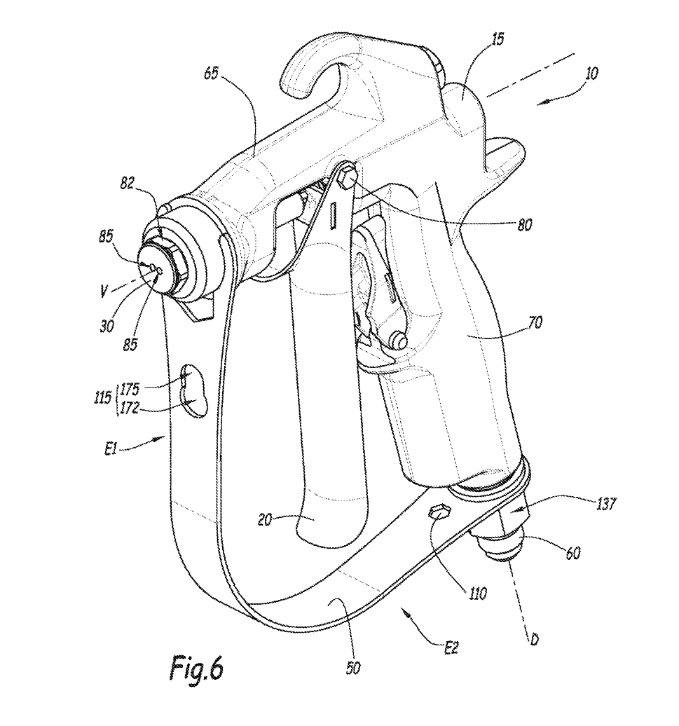

In a second embodiment, shown in FIG. 6, the removal means 115 are borne by the first end E1 and the disassembly means 110 are borne by the second end E2.

The operation of the second example is identical to the operation of the first example.

1. A fluid spray gun comprising a body made up of a barrel supporting a fluid spray nozzle and a handle having a cavity for receiving a filter, open opposite the barrel, and a guard suitable for protecting the hand of a user against impacts and preventing accidental operation in case of fall, the guard being removably mounted on the body and having a first end secured to the barrel and a second end secured to the handle,
wherein the guard comprises means for removing the filter from the cavity.

2. The gun according to claim 1, wherein the filter is translatable relative to the handle and can be removed from the cavity, along a longitudinal direction of the handle moving away from the barrel, and the removal means able to secure the filter and the guard in translation along this direction.

3. The gun according to claim 1, wherein the filter has a groove and the removal means of the guard have a notch, the edge of which is configured to be engaged in the groove.

4. The gun according to claim 3, wherein the guard is formed in a single piece.

5. The gun according to claim 1, wherein the first end has two elastic arms, the free ends, of which are configured to be engaged in two corresponding housings on the barrel.

6. The gun according to claim 1, further comprising a maintaining element able to be secured to the handle in a first position in which the maintaining element prevents the removal of the filter from the cavity,
wherein the guard further includes means for maneuvering the maintaining element relative to the handle.

7. The gun according to claim 6, wherein the maintaining element is able to be screwed to the handle and the maneuvering means are able to screw or unscrew the maintaining element relative to the handle.

8. The gun according to claim 7, wherein the maintaining element has a polygonal exterior shape and the maneuvering means have a cavity with a shape complementary to the exterior shape of the maintaining element.

9. The gun according to claim 1, wherein the barrel bears a seat casing able to receive a seat of a fluid spray nozzle by bearing, the seat casing being screwed to the barrel and the guard further including means for unscrewing the seat casing relative to the barrel, while the gun further includes a trigger pivoting around an axis traversing the body, and the guard includes means for disassembling the axis relative to the body.

10. A filter for a fluid spray gun according to claim 1, the filter having a third end oriented toward the top of the handle and a fourth end oriented toward the bottom of the handle when the filter is received in the cavity,
wherein the fourth end comprises means complementary to the removal means.

11. The filter according to claim 10, wherein the fourth end has a cylindrical fluid intake opening,
wherein the cylindrical opening has a polygonal base.

12. A method for removing a filter from the handle of a fluid spray gun, comprising a body made up of a barrel supporting a fluid spray nozzle and a handle having a cavity for receiving a filter, open opposite the barrel, and a guard suitable for protecting the hand of a user against impacts, the guard having a first end secured to the barrel and a second end secured to the handle,
the method comprising the following steps:
separating the first end and the barrel,
securing the guard and the filter in translation, and
removing the filter from the cavity using the guard.
